(19) United States
(12) Patent Application Publication
(10) Pub. No.: US 2016/0078029 A1
(43) Pub. Date: Mar. 17, 2016

(54) PHOTOGRAPHY DATA SHARING METHOD

(71) Applicant: Sightour Inc., New Taipei City (TW)

(72) Inventors: SHI-MU SUN, New Taipei (TW); HUAH TU, Taipei (TW)

(21) Appl. No.: 14/593,365

(22) Filed: Jan. 9, 2015

(30) Foreign Application Priority Data
Sep. 11, 2014 (TW) 103131436

(51) Int. Cl. G06F 17/30; G06K 9/00; G06K 9/62

(52) U.S. Cl. CPC G06F 17/3028; G06K 9/627; G06K 9/00288; G06K 9/00718; G06F 17/30256; G06F 17/30268; G06F 17/30274

(57) ABSTRACT

A photography data sharing method adapted to be used with a network sharing system. The network sharing system is configured to store and analyze at least a photography data. Each photography data includes an event information about the respective photography shooter generating the photography data. The network sharing system includes a database, a processing unit and a browser interface. The photography data sharing method includes steps of: storing the photography data; analyzing the event information of the photography data; determining whether the photography viewer and the event information of the photography data belong to a same event or not when the photography viewer is trying to browse the photography data through the browser interface; and providing the photography data to the photography viewer through the browser interface when it is determined that the photography viewer and the event information of the photography data belong to the same event.

### FIELD OF THE INVENTION

The present invention relates to a photography data sharing method, and more particularly to a photography data sharing method capable of automatically classifying all the persons related with the photography data.

### BACKGROUND OF THE INVENTION

Today, more and more people like to share their own shooting or interesting videos or photos with friends and family. In addition, some people even upload their videos or photos onto a variety of network communication platforms (such as Facebook or blog), and others can directly browse these videos or photos through the network communication platforms.

However, if a photography shooter shoots a lot of videos or photos in different activities and a photography viewer (for example, the photography shooter of the videos or photos or any person related to a specific event of these videos or photos) just wants to browse the videos or photos related with himself/herself, the photography viewer must filter these videos or photos by himself/herself.

Because so many people can browse these videos or photos through the network communication platform, it is a very time-consuming and laborious work to classify these videos or photos for each photography viewer.

Therefore, it is quite necessary to provide a photography data sharing method capable of automatically classifying all the videos or photos according to various activities so that the photography viewer can efficiently browse these videos or photos only related with him/her.

### SUMMARY OF THE INVENTION

Therefore, one object of the present invention is to provide a photography data sharing method capable of analyzing and classifying the photography data.

Another object of the present invention is to provide a photography data sharing method capable of automatically filtering out all the viewers unrelated with the photography data.

Still another object of the present invention is to provide a photography data sharing method having higher convenience for photography data browsing.

The present invention provides a photography data sharing method adapted to be used with a network sharing system. The network sharing system is configured to store and analyze at least a photography data. The photography data is provided by at least a photography shooter and for being browsed by at least a photography viewer. Each photography data includes an event information about the respective photography shooter generating the photography data. The network sharing system includes a database, a processing unit and a browser interface. The photography data sharing method includes steps of: a) configuring the database to store the photography data; b) configuring the processing unit to analyze the event information of the photography data; c) configuring the processing unit to determine whether the photography viewer and the event information of the photography data belong to a same event or not when the photography viewer is trying to browse the photography data through the browser interface; and d) configuring the processing unit to provide the photography data to the photography viewer through the browser interface when it is determined that the photography viewer and the event information of the photography data belong to the same event.

In summary, through the photography data sharing method provided by the present invention, not only the photography data can be classified according to the respective event information but also the photography viewer(s) being trying to browse the photography data can be filtered based on whether the on-site time information of this photography viewer is within a time range of the shoot-time information of the to-be-browsed photography data or not and whether the on-site location information of this photography viewer is matched with the shoot-location information of the to-be-browsed photography data or not. Thus, the photography viewer who actually participates the activity can browse the respective electronic photographs or video medias. In addition, the photography viewer(s) able to browse the photography data may be designated by the photography shooter(s). In addition, the permission of being able to browse the photography data may be determined by the network sharing system itself through performing a face recognition for all the persons occurring in the photography data. In addition, all the photography data belonging to one same activity is stored together in the database, and accordingly it is much convenient and efficient for the photography viewer to browse the photography data.

### BRIEF DESCRIPTION OF THE DRAWINGS

FIG. 1 is schematic block view of a network sharing system;

FIG. 2 is schematic flowchart of a photography data sharing method in accordance with an embodiment of the present invention;

FIG. 3 is schematic flowchart of a photography data sharing method in accordance with another embodiment of the present invention;

FIG. 4 is schematic flowchart of a photography data sharing method in accordance with another embodiment of the present invention;

FIG. 5 is schematic flowchart of a photography data sharing method in accordance with another embodiment of the present invention;

FIG. 6 is schematic flowchart of a photography data sharing method in accordance with another embodiment of the present invention; and

FIG. 7 is schematic flowchart of a photography data sharing method in accordance with another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention is related to a photography data sharing method, which is adapted to be used with a network sharing system. The network sharing system is configured to store and analyze photography data. The photography data is provided by a photography shooter(s) and can be browsed by a photography viewer(s); wherein the photography data may have electronic photograph format or video media format.

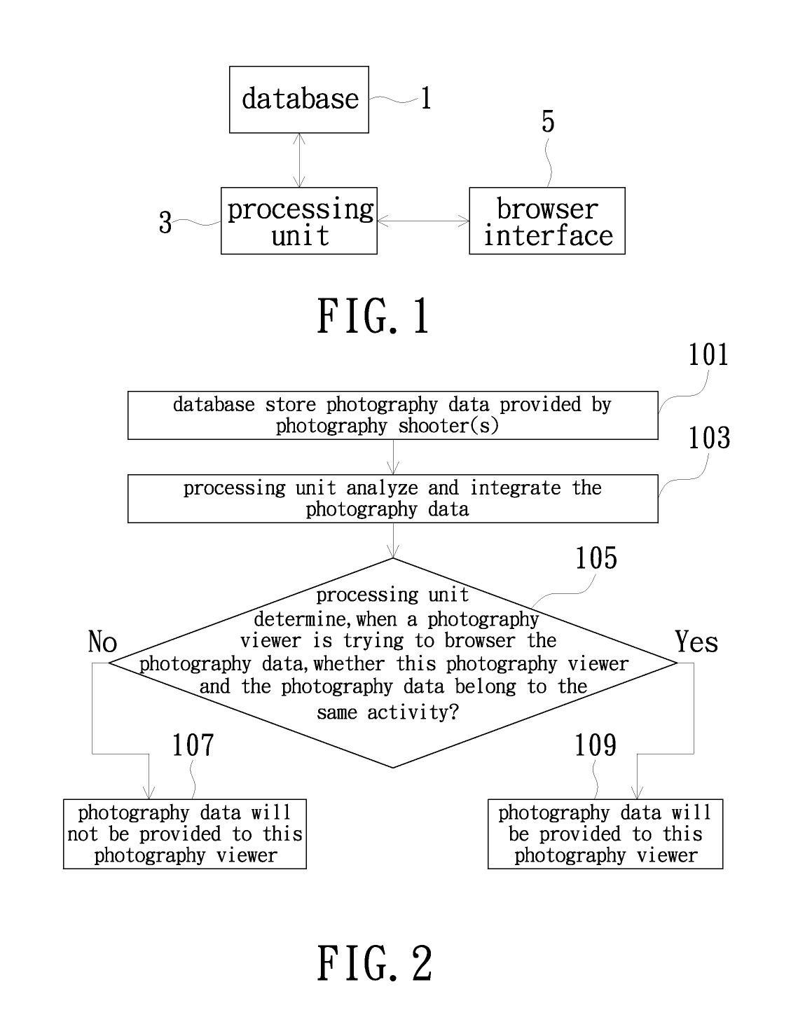

FIG. 1 is schematic block view of the aforementioned network sharing system. As shown, the network sharing system includes a database 1, a processing unit 3 and a browser interface 5. The browser interface 5 may be a Web album page, and the photography viewer(s) can browse the photography data through handheld devices (such as smart phones, tablet PCs, etc.) or computers which are signal connected to the aforementioned Web album page. The present embodiment is exemplarily illustrated based on that all of the photography shooter(s) and photography viewer(s) participate a same activity. When a photography shooter uploads his/her photography data to the network sharing system, a respective event information about this photography shooter being generating his/her photography data (for example, the photography shooter shooting a photograph or recording a video) is uploaded to the network sharing system accompanied with his/her photography data. In one embodiment, the event information contains a shoot-time information, which indicates the time when the photography shooter generates his/her photography data, and a shoot-location information, which indicates the location where the photography shooter generates his/her photography data.

For example, if the photography data is generated by smart phone or photographic equipment signal connected to a smart phone, the shoot-time information and the shoot-location information may be automatically generated by the positioning function of the smart phone and are uploaded to the network sharing system along with the photography data. Additionally, the photography viewer(s) in the present invention is referred to as another photography shooter(s) or any person related with and actually participating the activity. In addition, through the positioning function of smart phone, each photography viewer can upload has/her on-site time information, which indicates the time when the photography viewer participates the activity, and on-site location information, which indicates the location where the photography viewer participates the activity, to the network sharing system.

FIG. 2 is schematic flowchart of a photography data sharing method in accordance with an embodiment of the present invention. Please refer to FIGS. 1, 2 together. First, the database 1 stores the photography data provided by the photography shooter(s) (step 101). Next, the processing unit 3 analyzes and integrates the event information of the stored photography data (step 103).

Next, the processing unit 3 determines, when a photography viewer is trying to browser the photography data through the browser interface 5, whether this photography viewer and the to-be-browsed photography data belong to the same activity or not (step 105). In the present embodiment, the aforementioned determination is based on whether the on-site time information of this photography viewer is within a time range of the shoot-time information of the to-be-browsed photography data or not and whether the on-site location information of this photography viewer is matched with the shoot-location information of the to-be-browsed photography data or not. Specifically, if the on-site time information of this photography viewer is not within a time range of the shoot-time information of the to-be-browsed photography data, it is determined that this photography viewer does not participate this activity and accordingly the photography data will not be provided to this photography viewer (step 107).

Alternatively, if the on-site time information of this photography viewer is within a time range of the shoot-time information of the to-be-browsed photography data, it is determined that this photography viewer has participated this activity and accordingly the photography data will be provided to this photography viewer (step 109).

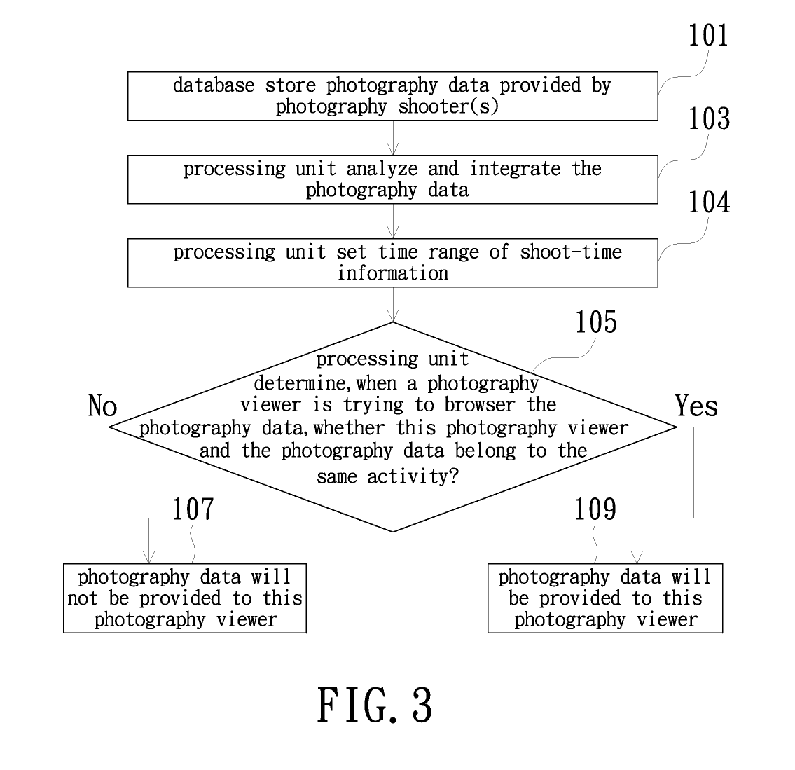

FIG. 3 is schematic flowchart of a photography data sharing method in accordance with another embodiment of the present invention. In the present embodiment, the photography viewer, who only participates a part of a relatively-long activity, is able to browse all the photography data of the activity through configuring the time range of the shoot-time information of the photography data to be adjustable. Compared with the photography data sharing method of FIG. 2, the photography data sharing method in the present embodiment of FIG. 3 further includes a step of: configuring the processing unit 3 to set the time range of the shoot-time information (step 104); wherein the step 104 is right after the step 103. In one embodiment, the time range of the shoot-time information may be set to cover the duration of the activity from the beginning to the end. Accordingly, any photography viewer, who has been at the location where the activity performed within the set time range, can browser the photography data. The remaining steps in the photography data sharing method in the present embodiment of FIG. 3 are same as that of FIG. 2, and no redundant detail is to be given herein.

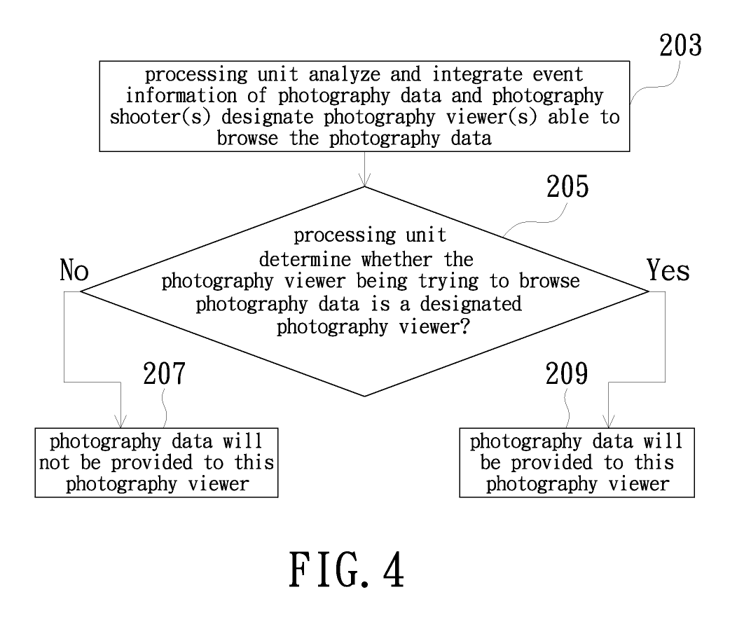

FIG. 4 is schematic flowchart of a photography data sharing method in accordance with another embodiment of the present invention. In the present embodiment, the photography viewer(s) allowed to browse the photography data is designated by the respective photography shooter(s). Please refer to FIGS. 1, 4 together. First, the processing unit 3 analyzes and integrates the event information of the photography data and the photography shooter(s) designates one or more photography viewers able to browse the photography data (step 203). Next, the processing unit 3 determines whether the photography viewer trying to browse the photography data through the browser interface 5 is a designated photography viewer or not (step 205). If the photography viewer trying to browse the photography data is not a designated photography viewer, the photography data will not be provided to this photography viewer (step 207). Alternatively, the photography data will be provided to the photography viewer if this photography viewer being trying to browse the photography data is a designated photography viewer (step 209).

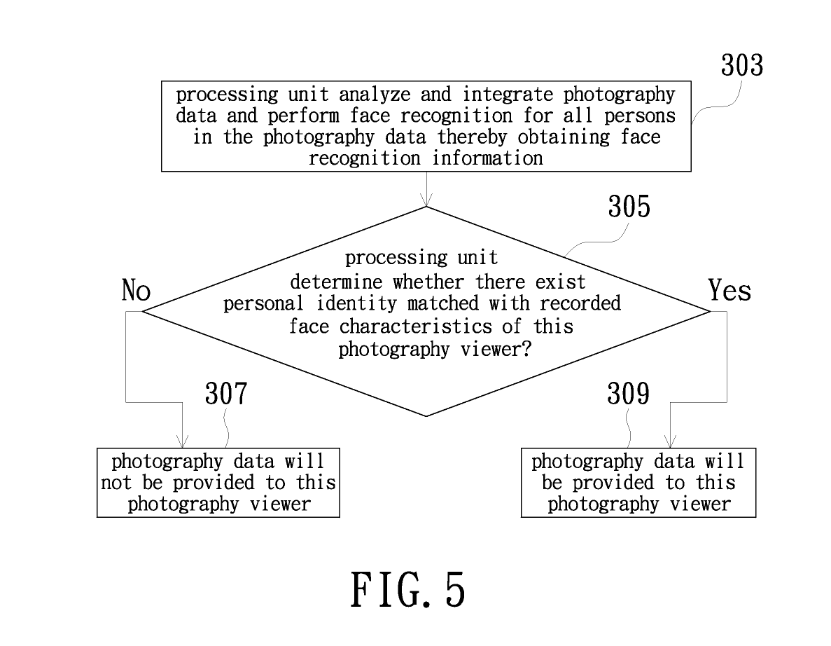

FIG. 5 is schematic flowchart of a photography data sharing method in accordance with another embodiment of the present invention. In the present embodiment, the permission of being able to browse the photography data is determined by the network sharing system itself; and correspondingly, the photography viewer(s) has to establish has/her personal identity and record his/her face characteristics in the network sharing system in advance. Please refer to FIGS. 1, 5 together. First, the processing unit 3 analyzes and integrates the photography data stored in the database 1 and performs a face recognition for all the persons occurring in the photography data thereby obtaining face recognition information (step 303); wherein each face recognition information corresponds to a personal identity, and each personal identity corresponds to a face (or person) occurring in the photography data. Next, when a photography viewer is trying to browse the photography data through the browser interface 5, the processing unit 3 determines whether there exists a personal identity matched with the recorded face characteristics of this photography viewer or not (step 305). If there is no personal identity matched with the recorded face characteristics of this photography viewer being trying to browse the photography data, the photography data will not be provided to this photography viewer (step 307). Alternatively, the photography data will be provided to the photography viewer if there exists a personal identity matched with the recorded face characteristics of this photography viewer trying to browse the photography data (step 309).

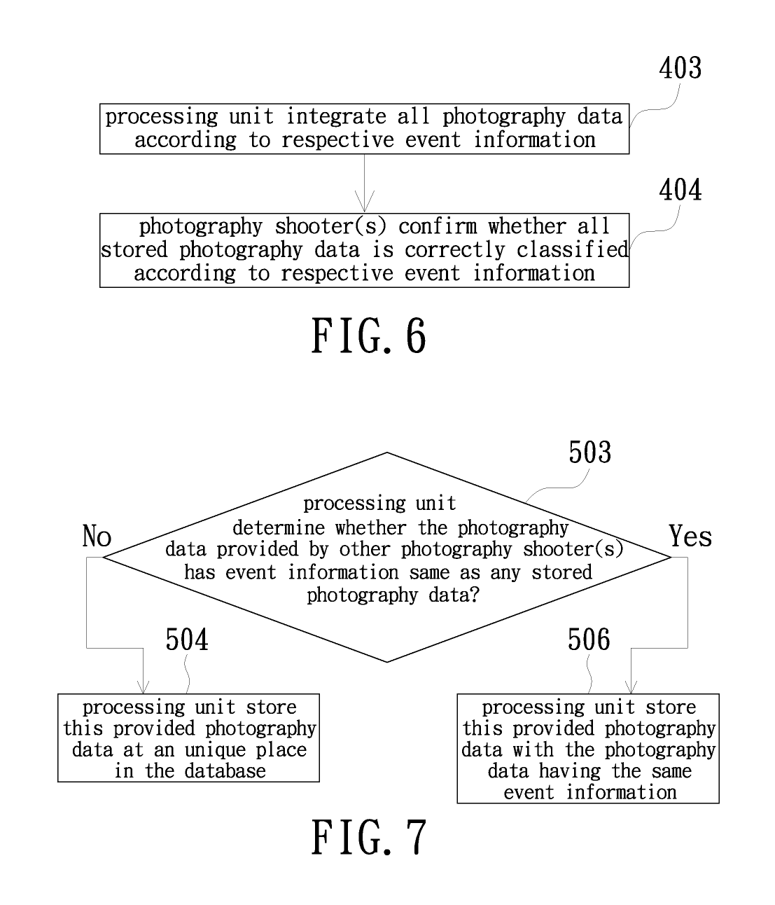

FIG. 6 is schematic flowchart of a photography data sharing method in accordance with another embodiment of the present invention. In the present embodiment, the photography data stored in the database 1 has higher integration. Please refer to FIGS. 1 and 6 together. First, the processing unit 3 integrates all the photography data according to the respective event information and stores the integrated photography data into the database 1 according to the respective event information (step 403). Next, the photography shooter(s) examines the integrated photography data to confirm whether all the stored photography data is correctly classified according to the respective event information (step 404). The confirmation process is completed once the photography shooter(s) confirms that all the stored photography data is correctly classified according to the respective event information and issues a confirmation instruction to the processing unit 3.

FIG. 7 is schematic flowchart of a photography data sharing method in accordance with another embodiment of the present invention. In the present embodiment, the photography data stored in the database 1 has higher integration. Please refer to FIGS. 1 and 7 together. First, the processing unit 3 determines whether the photography data provided by other photography shooter(s) has the event information same as any photography data stored in the database 1 or not (step 503). If this provided photography data has event information different with the photography data stored in the database 1, this provided photography data is stored at an unique place in the database 1 (step 504). Alternatively, if this provided photography data has event information same as any photography data stored in the database 1, this provided photography data is stored in the database 1 with the photography data having the same event information (step 506). Accordingly, all the photography data belonging to one same activity is stored together in the database 1.

In summary, through the photography data sharing method provided by the present invention, not only the photography data can be classified according to the respective event information but also the photography viewer(s) being trying to browse the photography data can be filtered based on whether the on-site time information of this photography viewer is within a time range of the shoot-time information of the to-be-browsed photography data or not and whether the on-site location information of this photography viewer is matched with the shoot-location information of the to-be-browsed photography data or not. Thus, the photography viewer actually participating the activity can browse the respective electronic photographs or video medias. In addition, the photography viewer(s) able to browse the photography data may be designated by the photography shooter(s). In addition, the permission of being able to browse the photography data may be determined by the network sharing system itself through performing a face recognition for all the persons occurring in the photography data. In addition, all the photography data belonging to one same activity is stored together in the database, and accordingly it is much convenient and efficient for the photography viewer to browse the photography data.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A photography data sharing method adapted to be used with a network sharing system, the network sharing system being configured to store and analyze at least a photography data, the photography data being provided by at least a photography shooter and for being browsed by at least a photography viewer, each photography data comprising an event information about the respective photography shooter generating the photography data, the network sharing system comprising a database, a processing unit and a browser interface, the photography data sharing method comprising steps of:
a) configuring the database to store the photography data;
b) configuring the processing unit to analyze the event information of the photography data;
c) configuring the processing unit to determine whether the photography viewer and the event information of the photography data belong to a same event or not when the photography viewer is trying to browse the photography data through the browser interface; and
d) configuring the processing unit to provide the photography data to the photography viewer through the browser interface when it is determined that the photography viewer and the event information of the photography data belong to the same event.

2. The photography data sharing method according to claim 1, wherein each event information of the respective photography data comprises a shoot-time information and a shoot-location information, and correspondingly the step b) further comprises a sub-step e1) configuring the processing unit to analyze the shoot-time information and the shoot-location information.

3. The photography data sharing method according to claim 2, wherein the processing unit is further configured to receive an on-site time information and an on-site area information respectively uploaded by each photography viewer, and correspondingly the step c) further comprises a sub-step e2) configuring the processing unit to determine whether the on-site time information is within a time range of the shoot-time information of the respective photography data or not and determine whether the on-site location information is matched with the shoot-location information of the respective photography data or not.

4. The photography data sharing method according to claim 3, wherein the step b) further comprises a sub-step e3) configuring the processing unit to set the time range of the shoot-time information.

5. The photography data sharing method according to claim 1, wherein the step b) further comprises a sub-step f1) configuring the processing unit to receive a notice indicating which photography viewer is designated by the photography shooter and provide the corresponding photography data to the designated viewer for browsing.

6. The photography data sharing method according to claim 5, wherein the step c) further comprises a sub-step f2) configuring the processing unit to determine whether the photography viewer trying to browse the respective photography data is the designated photography viewer or not.

7. The photography data sharing method according to claim 1, wherein the step b) further comprises a sub-step g1) configuring the processing unit to analyze the photography data and perform a face recognition, thereby obtaining at least a face recognition information, wherein each face recognition information corresponds to a personal identity.

8. The photography data sharing method according to claim 7, wherein the step c) further comprises a sub-step g2) configuring the processing unit to determine whether the photography viewer trying to browse the respective photography data is matched with the personal identity of the respective face recognition information.

9. The photography data sharing method according to claim 1, wherein the photography data has an electronic photograph format.

10. The photography data sharing method according to claim 1, wherein the photography data has a video media format.

11. The photography data sharing method according to claim 1, wherein the step b) further comprises sub-steps of:
j1) configuring the processing unit to integrate the photography data according to the respective event information and then store the integrated photography data; and
j2) configuring the processing unit to receive a confirming instruction from the photography shooter thereby confirming the photography data has been correctly classified according to the respective event information.

12. The photography data sharing method according to claim 1, wherein the step b) further comprises sub-steps of:
k1) configuring the processing unit to determine whether the photography data provided by another photography shooter has the same event formation or not; and
k2) configuring the processing unit to integrate and store all the photography data having the same event formation.
